(19) United States
(12) Patent Application Publication
(10) Pub. No.: US 2025/0192268 A1
(43) Pub. Date: Jun. 12, 2025

(54) STRUCTURAL THERMAL BARRIER ASSEMBLIES FOR USE WITHIN TRACTION BATTERY PACKS

(71) Applicant: FORD GLOBAL TECHNOLOGIES, LLC, Dearborn, MI (US)

(72) Inventors: Mohammadreza EFTEKHARI, Novi, MI (US); Michael E. REIBLING, Sterling Heights, MI (US); Kanchana PERUMALLA, Troy, MI (US); Jeffrey Scott DAHL, Livonia, MI (US)

(21) Appl. No.: 18/643,341

(22) Filed: Apr. 23, 2024

Related U.S. Application Data
(60) Provisional application No. 63/607,888, filed on Dec. 8, 2023.

(51) Int. Cl. H01M 10/6551; H01M 10/653; H01M 10/6554; H01M 10/658; H01M 50/249; H01M 50/289

(52) U.S. Cl. CPC H01M 10/6551; H01M 10/653; H01M 10/6554; H01M 10/658; H01M 50/249; H01M 50/289

(57) ABSTRACT

Structural thermal barrier assemblies are provided for traction battery packs. An exemplary structural thermal barrier assembly may be configured to both inhibit the transfer of thermal energy inside the traction battery pack and to increase the structural integrity of the traction battery pack. In some implementations, the structural thermal barrier assembly may establish a basin for receiving an adhesive. In other implementations, the structural thermal barrier assembly may include a pultruded thermal barrier fin.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to structural thermal barrier assemblies for use within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery cell stack, and a structural thermal barrier assembly arranged to partition the battery cell stack into at least a first compartment and a second compartment. A thermal barrier fin of the structural thermal barrier assembly is arranged to structurally couple an upper enclosure structure and a lower enclosure structure of the traction battery pack. The thermal barrier fin is a pultrusion.

In a further non-limiting embodiment of the foregoing traction battery pack, the upper enclosure structure is part of an enclosure cover of the traction battery pack, and the lower enclosure structure is part of a heat exchanger plate of the traction battery pack.

In a further non-limiting embodiment of either of the foregoing traction battery packs, the thermal barrier fin includes a T-shaped cross-section.

In a further non-limiting embodiment of any of the foregoing traction battery packs, the thermal barrier fin includes a polymer composite structure.

In a further non-limiting embodiment of any of the foregoing traction battery packs, the polymer composite structure includes a glass fiber reinforced polypropylene with an intumescent additive.

In a further non-limiting embodiment of any of the foregoing traction battery packs, the thermal barrier fin is flanked by aerogel layers and foam layers to establish a multi-layer sandwich structure of the structural thermal barrier assembly.

In a further non-limiting embodiment of any of the foregoing traction battery packs, the thermal barrier fin includes an upper interfacing structure configured to interface with the upper enclosure structure.

In a further non-limiting embodiment of any of the foregoing traction battery packs, the upper interfacing structure includes a basin configured to receive an adhesive.

In a further non-limiting embodiment of any of the foregoing traction battery packs, the thermal barrier fin includes a lower interfacing structure configured to interface with the lower enclosure structure. A thermal interface material is disposed between the lower interfacing structure and the lower enclosure structure.

In a further non-limiting embodiment of any of the foregoing traction battery packs, the lower interfacing structure includes a notched section configured for accommodating a contour of the lower enclosure structure.

A traction battery pack according to another exemplary aspect of the present disclosure includes, among other things, an upper enclosure structure and a structural thermal barrier assembly including a thermal barrier fin configured to establish a first sealed interface relative to the upper enclosure structure. The thermal barrier fin includes an upper interfacing structure that includes a basin, and an adhesive is received within the basin.

In a further non-limiting embodiment of the foregoing traction battery pack, the thermal barrier fin is a pultruded structure of the structural thermal barrier assembly.

In a further non-limiting embodiment of either of the foregoing traction battery packs, the thermal barrier fin includes a lower interfacing structure that is configured to establish a second sealed interface relative to a lower enclosure structure of the traction battery pack.

In a further non-limiting embodiment of any of the foregoing traction battery packs, the upper enclosure structure is part of an enclosure cover of the traction battery pack, and the lower enclosure structure is part of a heat exchanger plate of the traction battery pack.

In a further non-limiting embodiment of any of the foregoing traction battery packs, a thermal interface material is disposed between the lower interfacing structure of the thermal barrier fin and the heat exchanger plate.

In a further non-limiting embodiment of any of the foregoing traction battery packs, the lower interfacing structure includes a notched section that is configured for accommodating a contour of the heat exchanger plate.

In a further non-limiting embodiment of any of the foregoing traction battery packs, the basin extends between upwardly extending walls of the upper interfacing structure.

In a further non-limiting embodiment of any of the foregoing traction battery packs, a tab projects in an outboard direction away from each of the upwardly extending walls.

In a further non-limiting embodiment of any of the foregoing traction battery packs, the tab includes a shelf that is configured to support an insulation shield.

In a further non-limiting embodiment of any of the foregoing traction battery packs, the insulation shield is a mica sheet.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view of select portions of a cell stack of a traction battery pack.

FIG. 4 illustrates a thermal barrier fin of a thermal barrier assembly.

FIG. 5 illustrates another exemplary thermal barrier fin of a thermal barrier assembly.

FIG. 6 is a cross-sectional view of select portions of another exemplary cell stack of a traction battery pack.

### DETAILED DESCRIPTION

This disclosure details structural thermal barrier assemblies for traction battery packs. An exemplary structural thermal barrier assembly may be configured to both inhibit the transfer of thermal energy inside the traction battery pack and to increase the structural integrity of the traction battery pack. In some implementations, the structural thermal barrier assembly may establish a basin for receiving an adhesive. In other implementations, the structural thermal barrier assembly may include a pultruded thermal barrier fin. These and other features are discussed in greater detail in the following paragraphs of this detailed description.

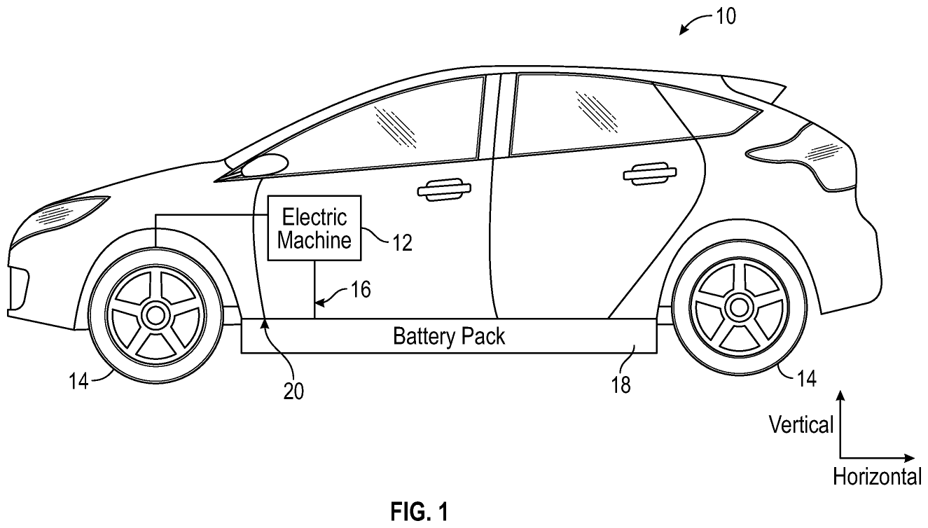

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

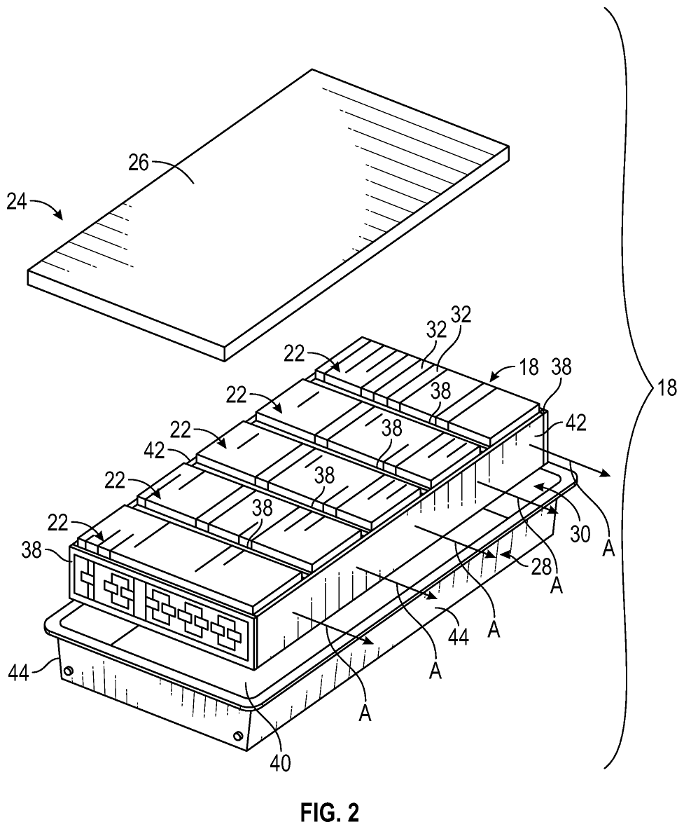

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together side-by-side to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

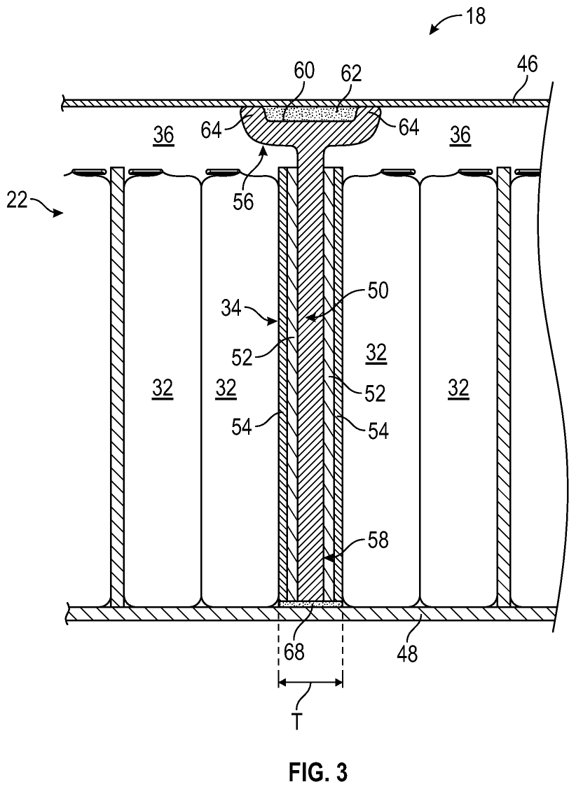

Referring now to FIG. 3, with continued reference to FIGS. 1-2, one or more structural thermal barrier assemblies 34 may be arranged along the respective cell stack axis A of each cell stack 22. The structural thermal barrier assemblies 34 may compartmentalize each cell stack 22 into two or more groupings or compartments 36 of battery cells 32. Each compartment 36 may hold one or more of the battery cells 32 of the cell stack 22.

Should, for example, a battery thermal event occur in one of the cell stacks 22, the structural thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. As further explained below, the structural thermal barrier assemblies 34 may further be configured to structurally join battery structures to increase the structural integrity of the traction battery pack 18.

Each structural thermal barrier assembly 34 may be configured to establish a sealed interface at both an upper enclosure structure 46 and a lower enclosure structure 48 of the traction battery pack 18. The upper enclosure structure 46 may be part of the enclosure cover 26 of the enclosure assembly 24 or could be an intermediate structure (e.g., a heat exchanger plate) that is positioned between the structural thermal barrier assembly 34 and the enclosure cover 26. The lower enclosure structure 48 may be part of the heat exchanger plate 40 that is positioned between the structural thermal barrier assembly 34 and the enclosure tray 28 or could be part of the enclosure tray 28.

Each structural thermal barrier assembly 34 may include a thermal barrier fin 50 that is flanked by aerogel layers 52 and foam layers 54 as part of a multi-layer sandwich structure of the structural thermal barrier assembly 34. The thermal barrier fin 50 may include a polymer composite structure (e.g., glass fiber reinforced polypropylene with an intumescent additive), the aerogel layers 52 may be encapsulated aerogel layers that include aerogel, a metallic sublayer (e.g., stainless steel), polyethylene terephthalate (PET) sublayers, and adhesive sublayers, and the foam layers 54 may include polyurethane foam or silicone foam, for example. However, other materials or combinations of materials could be utilized to construct the subcomponents of the structural thermal barrier assembly 34 within the scope of this disclosure

In an embodiment, a thickness T of the structural thermal barrier assembly 34 across the thermal barrier fin 50 and both the aerogel layers 52 and the foam layers 54 is about 10 mm. However, other configurations of the structural thermal barrier assembly 34 are possible within the scope of this disclosure. In this disclosure, the term “about” means that the expressed quantities or ranges need not be exact but may be approximated and/or larger or smaller, reflecting acceptable tolerances, conversion factors, measurement error, etc.

The thermal barrier fin 50 may be a pultrusion, which implicates structure to this component. A person of ordinary skill in the art having the benefit of this disclosure would understand how to structurally distinguish a pultruded structure from another type of structure, such as an extrusion, for example. The thermal barrier fin 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the thermal barrier fin 50. In other implementations, the thermal barrier fin 50 could be an injection molded part or an extruded part.

The thermal barrier fin 50 of the structural thermal barrier assembly 34 may include an upper interfacing structure 56 that is configured to interface with the upper enclosure structure 46, and a lower interfacing structure 58 that is configured to interface with lower enclosure structure 48. Together, the upper interfacing structure 56 and the lower interfacing structure 58 may establish a T-shaped cross-section of the thermal barrier fin 50. However, other shapes are contemplated within the scope of this disclosure.

The upper interfacing structure 56 may include a dish-like basin 60 for receiving and holding an adhesive 62. The basin 60 may be established by upwardly extending walls 64 of the upper interfacing structure 56. The adhesive 62 may be utilized to secure the structural thermal barrier assembly 34 to the upper enclosure structure 46. The adhesive 62 may be an epoxy based adhesive or a urethane based adhesive, for example. Once the upper interfacing structure 56 is secured relative to the upper enclosure structure 46, the structural thermal barrier assembly 34 substantially prevents thermal energy from moving from one compartment 36 to another at the sealed interface between the structural thermal barrier assembly 34 and the upper enclosure structure 46, such as during a battery thermal event, for example.

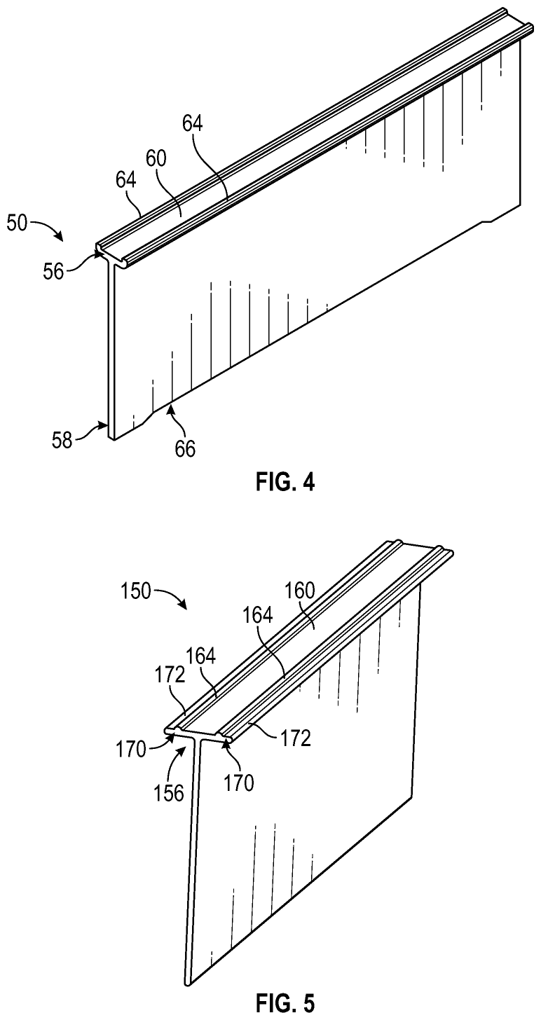

The lower interfacing structure 58 may be disposed on an opposite end of the thermal barrier fin 50 from the upper interfacing structure 56. The lower interfacing structure 58 may be substantially flat or could include a notched section 66 (see FIG. 4) configured for accommodating a contour of the lower enclosure structure 48. The lower interfacing structure 58 may therefore help locate the structural thermal barrier assembly 34 relative to the lower enclosure structure 48 during assembly.

The lower interfacing structure 58 may be fixedly secured to the lower enclosure structure 48 to increase the overall rigidity of the traction battery pack 18. A thermal interface material 68, which could be an adhesive or an insulation material, may be utilized to secure the lower interfacing structure 58 to the lower enclosure structure 48. The thermal interface material 68 could also have compliance properties for sealing purposes. The thermal interface material 68 (e.g., epoxy resin, silicone based materials, thermal greases, etc.) may additionally be disposed between the battery cells 32 of the cell stack 22 and the lower enclosure structure 48 for facilitating heat transfer therebetween.

Once the upper interfacing structure 56 is joined to the upper enclosure structure 46 and the lower interfacing structure 58 is joined to the lower enclosure structure 48, the upper and lower enclosure structures 46, 48 are effectively structurally coupled to one another. The structural thermal barrier assemblies 34 are therefore configured for increasing the structural stiffness of the traction battery pack 18. The structural thermal barrier assemblies 34 could additionally be structurally connected to the cross-member assembly 38 or to a busbar module with an adhesive and/or sealant.

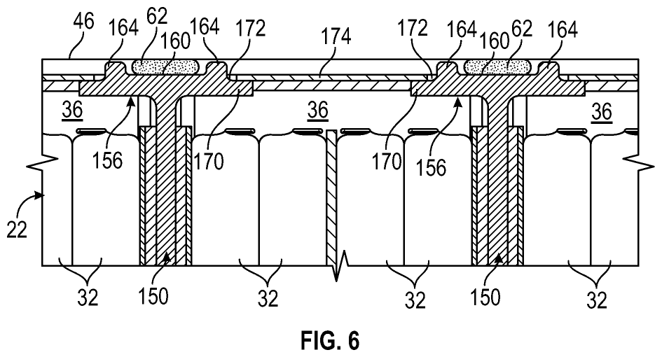

FIGS. 5 and 6 illustrate another exemplary thermal barrier fin 150 that could be utilized as part of the thermal barrier assemblies 34 described above. Similar to the thermal barrier fin 50, the thermal barrier fin 150 may include an upper interfacing structure 156 that includes a basin 160 established by upwardly extending walls 164. In addition, the upper interfacing structure 156 may include tabs 170 that project in an outboard direction away from the upwardly extending walls 164. Each tab 170 establishes a shelf 172 for supporting an insulation shield 174 (see FIG. 6) that may be arranged axially between the upper enclosure structure 46 and the cell stack 22. In an embodiment, the insulation shield 174 is a mica sheet that can extend from the tab 170 of one thermal barrier fin 150 to the tab 170 of another thermal barrier fin 150 of the cell stack 22. However, the insulation shield 174 could be constructed from other materials and/or arranged differently within the scope of this disclosure.

The structural thermal barrier assemblies of this disclosure provide for blocking gases and protecting adhesive from vent gas temperatures and debris while maintaining structure, sealing, and thermal resistance in a relatively thin profile compared to prior thermal barriers. The exemplary structural thermal barrier assemblies may include a thermal barrier fin designed to retain the adhesive during curing to limit spillage onto battery cells and/or to provide a shelf surface for supporting cover protection shields.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell stack;
a structural thermal barrier assembly arranged to partition the battery cell stack into at least a first compartment and a second compartment; and
a thermal barrier fin of the structural thermal barrier assembly arranged to structurally couple an upper enclosure structure and a lower enclosure structure of the traction battery pack,
wherein the thermal barrier fin is a pultrusion.

2. The traction battery pack as recited in claim 1, wherein the upper enclosure structure is part of an enclosure cover of the traction battery pack, and the lower enclosure structure is part of a heat exchanger plate of the traction battery pack.

3. The traction battery pack as recited in claim 1, wherein the thermal barrier fin includes a T-shaped cross-section.

4. The traction battery pack as recited in claim 1, wherein the thermal barrier fin includes a polymer composite structure.

5. The traction battery pack as recited in claim 4, wherein the polymer composite structure includes a glass fiber reinforced polypropylene with an intumescent additive.

6. The traction battery pack as recited in claim 1, wherein the thermal barrier fin is flanked by aerogel layers and foam layers to establish a multi-layer sandwich structure of the structural thermal barrier assembly.

7. The traction battery pack as recited in claim 1, wherein the thermal barrier fin includes an upper interfacing structure configured to interface with the upper enclosure structure.

8. The traction battery pack as recited in claim 7, wherein the upper interfacing structure includes a basin configured to receive an adhesive.

9. The traction battery pack as recited in claim 1, wherein the thermal barrier fin includes a lower interfacing structure configured to interface with the lower enclosure structure, and comprising a thermal interface material disposed between the lower interfacing structure and the lower enclosure structure.

10. The traction battery pack as recited in claim 9, wherein the lower interfacing structure includes a notched section configured for accommodating a contour of the lower enclosure structure.

11. A traction battery pack, comprising:
an upper enclosure structure;
a structural thermal barrier assembly including a thermal barrier fin configured to establish a first sealed interface relative to the upper enclosure structure;
the thermal barrier fin including an upper interfacing structure that includes a basin; and
an adhesive received within the basin.

12. The traction battery pack as recited in claim 11, wherein the thermal barrier fin is a pultruded structure of the structural thermal barrier assembly.

13. The traction battery pack as recited in claim 11, wherein the thermal barrier fin includes a lower interfacing structure that is configured to establish a second sealed interface relative to a lower enclosure structure of the traction battery pack.

14. The traction battery pack as recited in claim 13, wherein the upper enclosure structure is part of an enclosure cover of the traction battery pack, and the lower enclosure structure is part of a heat exchanger plate of the traction battery pack.

15. The traction battery pack as recited in claim 14, comprising a thermal interface material disposed between the lower interfacing structure of the thermal barrier fin and the heat exchanger plate.

16. The traction battery pack as recited in claim 14, wherein the lower interfacing structure includes a notched section that is configured for accommodating a contour of the heat exchanger plate.

17. The traction battery pack as recited in claim 11, wherein the basin extends between upwardly extending walls of the upper interfacing structure.

18. The traction battery pack as recited in claim 17, comprising a tab that projects in an outboard direction away from each of the upwardly extending walls.

19. The traction battery pack as recited in claim 18, wherein the tab includes a shelf that is configured to support an insulation shield.

20. The traction battery pack as recited in claim 19, wherein the insulation shield is a mica sheet.
